(19) United States
(12) Patent Application Publication
(10) Pub. No.: US 2014/0210403 A1
(43) Pub. Date: Jul. 31, 2014

(54) COIL FOR INDUCTIVE COUPLED POWER TRANSFER AND ELECTRICAL-FIELD COUPLED POWER TRANSFER

(71) Applicant: ESPOWER ELECTRONICS INC., New Taipei City (TW)

(72) Inventor: CHING CHI LIN, KEELUNG CITY (TW)

(73) Assignee: ESPOWER ELECTRONICS INC., NEW TAIPEI CITY (TW)

(21) Appl. No.: 13/751,075

(22) Filed: Jan. 26, 2013

(51) Int. Cl. H02J 7/00; H04B 5/00

(52) U.S. Cl. CPC H02J 7/0052; H04B 5/0037; H04B 5/0075
USPC 320/108

(57) ABSTRACT

The present invention relates to a coil for inductive coupled power transfer (ICPT) and electrical-field power transfer (ECPT). The structure of the coil includes a flat panel coil. The wire of the flat panel coil, whose shape is explanted, has a specific width. Also, the flat panel coil is winded on a plane surface. In the ICPT mode, the first terminal of the flat panel coil are inputted a first external voltage, and a magnetic field is outputted to charge a first external device through switching a switch which is coupled to the second terminal of the flat panel coil. In the ECPT mode, the second terminal is cut off, and the first terminal of the flat panel coil is inputted a second external voltage. An electrical field is outputted to charge a second external device through controlling the amplitude and frequency of the second external voltage.

### BACKGROUND OF THE INVENTION

1. Field of the Invention

The present invention relates to a technology of wireless recharging; and particularly to a coil for inductive coupled power transfer and electrical-field coupled power transfer.

2. Description of Related Art

User are use to carry the electrical device at any time with those devices are light and handy. The common electrical device likes mobile phone, PDA (Personal Digital Assistance), notebook, tablet, digital camera, and digital camcorder, etc. There is widely used for community and be indispensable for the part of modern science life.

For reducing the bother of recharging by using line, the concept of a wireless power system about the principle of electromagnetic induction has been proposed many years before. Because of the practical limitations of technology about previous electromagnetic induction, wireless charging system is subject to considerable restrictions. For instance, in order to provide reasonable efficiency of operation, the prior art about wireless inductive charging system needs to close and accurate alignment between the primary coil and the second coil. Additionally, there is needed high degree of coordinated tuning in inductive power supplying between electrical device and distance device. And there could need difference amount of power with difference distance device. Those problems may be more complex.

The technology of wireless recharging at present, just applies to one-to-one. In other word, the mobile device has matched to specific wireless recharging device. So, it isn't used compatible when the product is changed. Therefore, applicant provides a wireless power supplying system to support difference product compatibly.

### SUMMARY OF THE INVENTION

The object of the present invention is to provide a coil for inductive coupled power transfer and electrical-field coupled power transfer; which transfers power to distance device by magnetic field in inductive coupled power transfer mode or electrical field in electrical coupled power transfer mode.

In order to achieve the aforementioned or other objects, the present invention provides a coil for inductive coupled power transfer and electrical-field coupled power transfer. That outputs magnetic field power to charge the first distance device in inductive coupled power transfer mode; and outputs electrical-field power to charge the second distance device in electrical-field coupled power transfer mode. The coil for inductive coupled power transfer and electrical-field coupled power transfer is characterized of flat panel coil. The composition of coil has a specific width, and it is flat. And above flat panel coil winds on a panel, wherein the above panel is paralleled to flat panel coil. In inductive coupled power transfer mode, the coupled flat panel coil inputs a first external voltage from the first port and outputs magnetic-field power to charge first external device through by turning the switch of second port of coupled flat panel coil. In electrical-field coupled power mode, the first port above said inputs a second external voltage and the switch in second port of coupled flat panel coil is opened, which outputs electrical-field power to charge second external device through controlling the frequency and voltage of second external.

The spirit of the present invention is changing the shape of the coil wire to the flat shape, and the coil is configured in this same plane. Therefore, in inductive coupled power transfer mode, the coupled flat panel coil inputs a first external voltage from the first port and outputs magnetic-field power to charge first external device through by turning the switch of second port of coupled flat panel coil. In electrical-field coupled power mode, the first port above said inputs a second external voltage and the switch in second port of coupled flat panel coil is opened, which outputs electrical-field power to charge second external device through controlling the frequency and voltage of second external.

In order to further the understanding regarding the present invention, the following embodiments are provided along with illustrations to facilitate the disclosure of the present invention.

### BRIEF DESCRIPTION OF THE DRAWINGS

FIG. 1 shows the overlooked view of coil for inductive coupled power transfer and electrical-field coupled power transfer according to the first embodiment of the present invention.

FIG. 2 shows the circuit applies to inductive coupled power transfer (ICPT) by the coil for inductive coupled power transfer and electrical-field coupled power transfer according to the second embodiment of the present invention.

FIG. 3 shows the circuit applies to electrical-field coupled power transfer (ECPT) by the coil for inductive coupled power transfer and electrical-field coupled power transfer according to the second embodiment of the present invention.

FIG. 4 is the overlooked view of coil for inductive coupled power transfer and electrical-field coupled power transfer according to the fourth embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

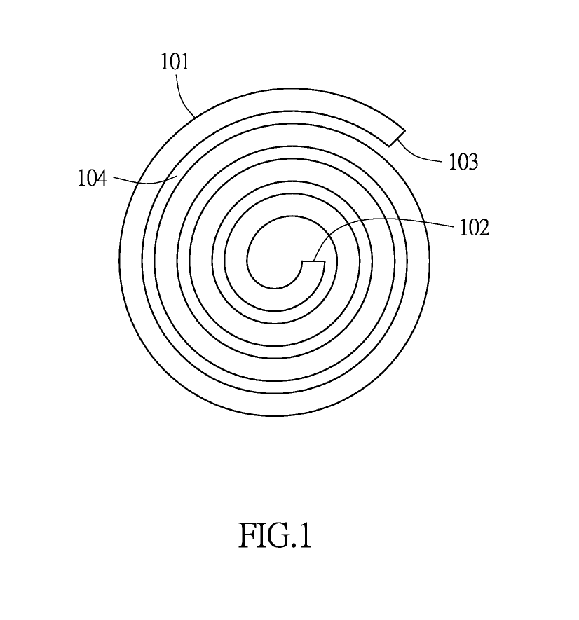

The FIG. 1 is shown the overlooked view of the coil for inductive coupled power transfer and electrical-field coupled power transfer according to the first embodiment of the present invention. Referring to FIG. 1, the coil for inductive coupled power transfer and electrical-field coupled power transfer includes a flat panel coil 101, the wire of flat panel coil 101 is configured in the plane and the width of coil wire is L. The wire of flat panel coil 101 is wound from the inside first port 102 to the outside second port 103. By the overlooked view of the coil for inductive coupled power transfer and electrical-field coupled power transfer, the construct is similar to a flat panel. The flat panel coil 101 could be seen as a metal flat panel that flat panel is residue down by the gap of flat panel coil 104 is etched away.

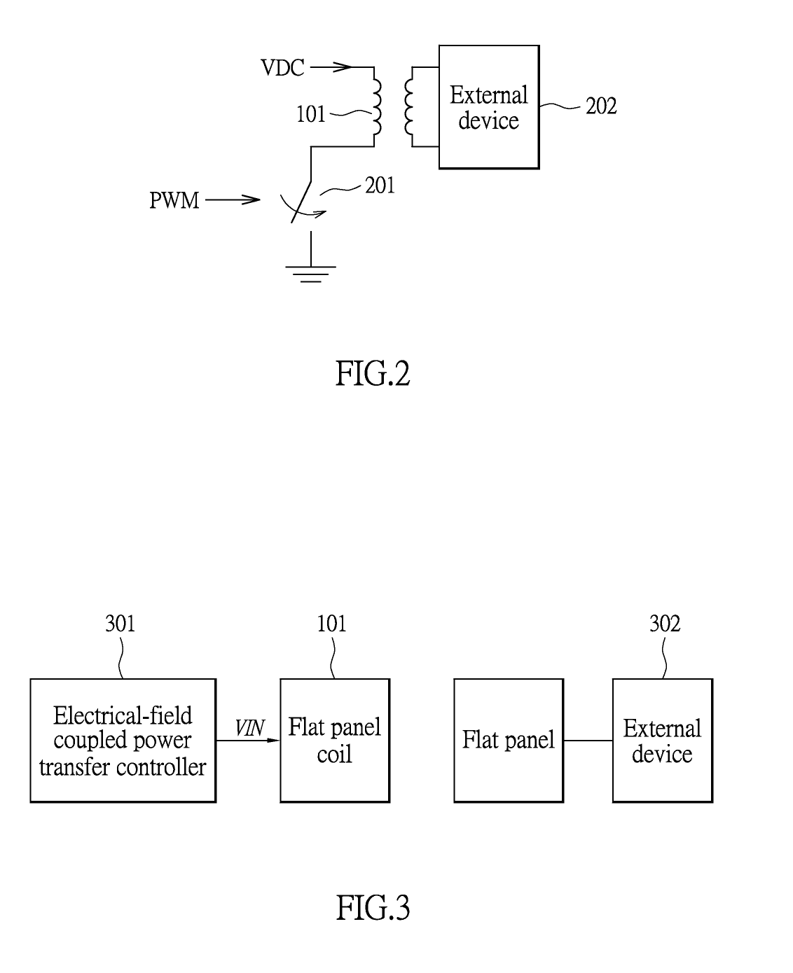

FIG. 2 is shown the circuit applies to inductive coupled power transfer (ICPT) by the coil for inductive coupled power transfer and electrical-field coupled power transfer according to the second embodiment of the present invention. Referring to FIG. 2, when the coil for inductive coupled power transfer and electrical-field coupled power transfer of FIG. 1 is used in inductive coupled power transfer mode, the flat panel coil 101 is used as wire. Therefore, the first port of wire is used to input voltage after rectifying VDC in the circuit construct (such as the 110V in Taiwan that is rectified after bridge rectifier). The second port of wire is coupled to controller switch 201 of PWM (Pulse Width Modulation). Whereby the controller switch 201 controls open/cut, which could transfer power to external device 202 by controlling the magnetic-field that flat panel coil 101 outputs.

FIG. 3 is shown the circuit applies to electrical-field coupled power transfer (ECPT) by the coil for inductive coupled power transfer and electrical-field coupled power transfer according to the second embodiment of the present invention. Referring to FIG. 3, when the coil for inductive coupled power transfer and electrical-field coupled power transfer of FIG. 1 is used in electrical-field coupled power (ECPT) transfer mode, the flat panel coil 101 is used as a flat panel. In here, the second port of flat panel coil 101 is coupled without anything In other word, that is isolated entirely. Electrical-field coupled power transfer controller 301 outputs electrical-field power to charging external device 302 by controlling the frequency and voltage of VIN. And in the electrical-field power transfer mode, the external device 302 should have a metal flat panel. The equivalent capacitance which is constituted by the metal flat panel on external device 302 and the flat panel coil 101 effects to the effective of transferring directly. Wherein the equivalent capacitance is calculated as follow:

C−A×ε_{O}×ε_{P}/d

C is expressed as equivalent capacitance, A is expressed as coupled field, d is expressed as distance of pole board, ε_{O} is expressed as absolute permittivity, εᵣ is expressed as relative permittivity. In general, absolute permittivity ε_{O} and relative permittivity εᵣ are fixed. Therefore, the coupled field A and distance of pole board d determine the value of equivalent capacitance. So, the metal flat panel affects the coupled field A directly. In this embodiment, the metal portion of the flat panel coil 101 occupies the area of circle constituted by the center to radius R of flat panel coil 101 over 80%. And in order to achieve the flat panel coil 101 occupies the area of circle over 80%, the width of the flat panel coil 101 above is designed greater than or equal to 5 mm, and the width of gap of flat panel coil 104 is designed less than 1 mm. Therefore, it not only increases equivalent capacitance C, but also increases the efficiency of electrical-field coupled transfer.

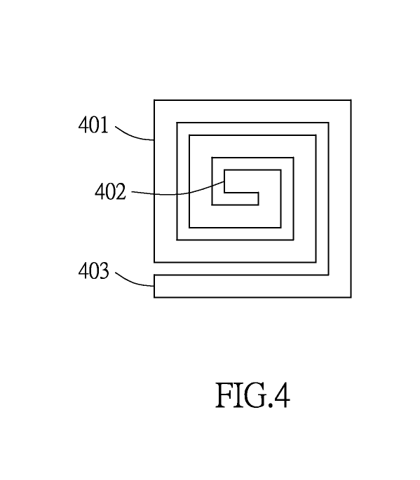

FIG. 4 is the overlooked view of coil for inductive coupled power transfer and electrical-field coupled power transfer according to the fourth embodiment of the present invention. Referring to FIG. 4, although the embodiment above is illustrated by circle coil. The embodiment is used rectangle to illustrate specially. For the same reason, the wire of flat panel coil 401 is configured in the plane and the width of coil wire is L. The wire of flat panel coil 401 is wound from the inside first port 402 to the outside second port 403 and appears as rectangle. The advantage of this type is that could be more fitted to the product of external device because of the general mobile device is designed as rectangle construct usually. Therefore, the coil is wound as rectangle that increases the coupled field A above actually.

Although the embodiment of above only illustrates by circle and rectangle, but it is easy to know that the shape of coil is changed in different design by the person skill in the art. Such as triangle, trapezoid, oval, etc. The present invention is not limited the type in here.

In summary, the spirit of the present invention is changing the shape of the coil wire to the flat shape, and the coil is configured in the same plane. In inductive coupled power transfer mode, the coupled flat panel coil inputs a first external voltage from the first port and outputs magnetic-field power to charge first external device through by turning the switch of second port of coupled flat panel coil. In electrical-field coupled power mode, the first port above said inputs a second external voltage and the switch in second port of coupled flat panel coil is opened, which outputs electrical-field power to charge second external device through controlling the frequency and voltage of second external.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A coil for inductive coupled power transfer and electrical-field coupled power transfer; that outputs magnetic field power to charge the first distance device in inductive coupled power transfer mode; and outputs electrical-field power to charge the second distance device in electrical-field coupled power transfer mode; the coil for inductive coupled power transfer and electrical-field coupled power transfer is characterized as:
a flat panel coil. The composition of coil has a specific width, and it is flat; and above flat panel coil winds on a plane, wherein the above panel is paralleled to flat panel coil;
wherein in inductive coupled power transfer mode, the coupled flat panel coil inputs a first external voltage from the first port and outputs magnetic-field power to charge first external device through by turning the switch of second port of coupled flat panel coil;
wherein in electrical-field coupled power transfer mode, the first port above said inputs a second external voltage and the switch in second port of coupled flat panel coil is opened, which outputs electrical-field power to charge second external device through controlling the frequency and voltage of second external.

2. The coil for inductive coupled power transfer and electrical-field coupled power transfer according to claim 1, wherein the width of the flat panel coil is greater than or equal to 5 mm.

3. The coil for inductive coupled power transfer and electrical-field coupled power transfer according to claim 1, wherein the width of gap of flat panel coil is less than 1 mm.

4. The coil for inductive coupled power transfer and electrical-field coupled power transfer according to claim 1, wherein the flat panel coil has a center and the flat panel coil is a concentric and radial winding from this center.

5. The coil for inductive coupled power transfer and electrical-field coupled power transfer according to claim 4, wherein the metal portion of the flat panel coil occupies the area of circle constituted by the center to radius R of flat panel coil over 80%.

6. The coil for inductive coupled power transfer and electrical-field coupled power transfer according to claim 1, wherein the flat panel coil has a center and the flat panel coil is a rectangular and radial winding from this center.

7. The coil for inductive coupled power transfer and electrical-field coupled power transfer according to claim 4, wherein the metal portion of the flat panel coil occupies the area of rectangular which surrounds forming the periphery of the flat panel of flat panel coil over 80%.
